(19) United States
(12) Patent Application Publication
(10) Pub. No.: US 2001/0032190 A1
(43) Pub. Date: Oct. 18, 2001

(54) Identification mark for storing information, device for writing information on the mark, mark processing system, and associated methods

(76) Inventors: Rainer Ediger, Bremen (DE); Thomas Gerhardt, Berlin (DE); Wolfgang Pekruhn, Berlin (DE); Michael Seikel, Berlin (DE)

Correspondence Address: LERNER AND GREENBERG, P.A., Post Office Box 2480, Hollywood, FL, 33020, US

(21) Appl. No.: 09/804,324

(22) Filed: Mar. 12, 2001

(30) Foreign Application Priority Data
Mar. 10, 2000 (DE) 100 11 858.5

(51) Int. Cl. G06F 17/60

(52) U.S. Cl. 705/62

(57) ABSTRACT

A mail identifier for storing information on mail includes an identification mark having a storage device for storing information and/or franking data associated with the mail. The storage device is contactlessly and wirelessly read. There is also provided a mail processing system processing the mail having the mark. A writer can contactlessly and wirelessly write information onto the mark, and a reader can similarly reads information associated with the mail. The device for processing items of mail can include a franking machine and/or a computer. A method of using of an identification mark includes placing an identification mark at an item of mail, storing at least one of information and franking data associated with an item of mail in the identification mark, and contactlessly and wirelessly reading the identification mark. A method of processing items of mail includes similar steps and simultaneously checks the validity of the franking data.

### BACKGROUND OF THE INVENTION

### Field of the Invention

The invention relates to an identification mark, which can be read without wires or contact, for storing information, a device for writing information on the mark, and a mark processing system. In addition, the invention relates to a writing device for writing information onto an identification mark that can be read and written without wires or contact, a mail processing system for processing items of mail, having a reading device for reading information associated with the item of mail, and a device for processing items of mail, in particular, a franking machine or a computer. In addition, the invention relates to an item of mail, in particular, a mail packaging material such as an envelope, package wrapper, and package carton, and a method of processing items of mail, information associated with the item of mail being read with a reading device.

In recent years, the franking of items of mail has developed from the electromechanical franking machine through the digitally printing franking machine using a thermal transfer technique to ink-jet franking machines, in which the printing unit operates on the ink-jet printing process. The driving force was the greater flexibility in the configuration of the franking imprint, which is required, in particular, in franking imprints that are intended to be individual to each item of mail, for example, to each letter. The most important benefit of an individual franking imprint is the possibility of storing and reproducing information in the franking imprint that permits correct franking to be checked and, if appropriate, of storing further information that facilitates the distribution and tracking of the item of mail, that is to say following it during transport and, if necessary, finding it when lost.

A franking machine for producing franking imprints, which is configured as a conventional personal computer with additional hardware and software, is disclosed, for example, in U.S. Pat. No. 5,717,597 to Kara. In addition, appliances that operate and are configured exclusively as a franking machine for producing such franking imprints exist in large numbers.

The requirements on the content of such digital franking imprints increase continuously. While at present a consecutive number with less than 10 digits is sufficient, national postal authorities, in particular, demand more and more storage space for storing information in these franking imprints. For example, the IBIP of the U.S. Postal Service requires 86 bytes to store variable information, and the Canadian Post desires 144 bytes of storage space. Future requirements, for example, to store personal information about the user of the franking machines in the franking imprints, can easily require a still higher amount of memory.

For example, Kara discloses the printing of the information to be stored onto the item of mail in the form of a two-dimensional bar code. Given a writing height of 1 inch and the requirement for still more reliable machine readability of the bar code, the amount of information that can be stored and printed is restricted to about 150 bytes. A larger quantity of information would mean an excessively great reduction in the size of the bar code elements and, therefore, poorer readability. Because of the uneven surface, the broad range of papers and the use of non-black inks, which have a lower contrast than black ink, adequate quality and information density cannot be achieved in the direct printing of items of mail, for example, of envelopes.

German Patent DE 43 36 897 C1 discloses an identification system having a transmitting/receiving appliance and an identification mark. The identification mark is configured as an ID tag (SAW-ID tag) that operates with surface acoustic waves. ID tags of this type are components in which an electrical signal is converted through a converter into a surface acoustic wave that is reflected at a series of reflectors, the reflected surface acoustic wave being capable of being converted into an electrical signal again by a converter, which may be identical with the converter that converted the electrical input signal. Depending on the configuration of the reflectors, the result is a predefined code representing the ID tag.

Furthermore, for example, in German Published, Non-Prosecuted Patent Application DE 42 00 076 A1 discloses identification marks that are configured as a passive surface wave sensor for determining a measured value. A measured value is transmitted by radio from the surface wave sensor disposed at a remote measurement location to an interrogation appliance, which transmits energy by radio to the sensor elements as an interrogation pulse.

As a modification, identification marks also exist that have, instead of a sensor element, a storage element that can be written many times.

The common factor in all such identification marks is that they operate passively, in other words, the energy for its own operation is taken by an antenna from the electromagnetic field of a reading appliance. Such identification marks, often also designated passive RF-ID tags (radio frequency identification tag), can be read out without wires or contact. It is possible in specific embodiments for the stored information also to be changed from outside without wires or contact. In prior art identification marks, the reading distance is up to one meter. In active identification marks, which likewise exist and which additionally have an energy store, the reading distance may also be a number of meters.

At present, a series of items of information is printed onto an item of mail in a digital and machine-readable franking imprint. However, the quantity of information that can be printed is limited.

### SUMMARY OF THE INVENTION

It is accordingly an object of the invention to provide an identification mark for storing information, a device for writing information on the mark, and a mark processing system that overcome the hereinafore-mentioned disadvantages of the heretofore-known devices and methods of this general type and that provides a cost-effective possibility of assigning to an item of mail a quantity of information that is unrestricted as far as possible and that can be read by machine quickly, simply, and reliably.

With the foregoing and other objects in view, there is provided, in accordance with the invention, a mail identifier for storing information at an item of mail, including an identification mark disposed at an item of mail, the identification mark having a storage device for storing at least one of information and franking data associated with the mail item, the storage device to be contactlessly and wirelessly read.

The objective of the invention is achieved in an identification mark that can be read without wires or contact and that is configured to store information and/or franking data associated with an item of mail and to be disposed in or on the item of mail.

The invention is based on the finding that it is more advantageous to store the information to be stored electronically, and no longer to print it directly onto the item of mail as a franking imprint. For the purpose of storage, the invention makes use of identification marks that can be read without wires or contacts because they are considerably cheaper and simpler to produce than, for example, semiconductor chips as are often used on chip cards or telephone cards, and which, in addition, have to be brought into contact with a reading appliance in order to be read.

The information associated with the item of mail is to be understood to mean any information that can be stored on the identification mark applied to the item of mail and dispatched together with the item of mail. In addition to the data relating directly to the item of mail or the content of the item of mail, the data can also be other, for example, personal information that can be stored on the identification mark and dispatched with it. As a result, the identification mark can be used advantageously as a data memory that is capable of being encrypted and on which security-relevant information that, for example, should not be sent in the item of mail in written form, is stored and dispatched. For example, even images, text, passwords, or PIN numbers may be contained in the identification mark, in encrypted or unencrypted form. In current identification marks, up to 1 MB of memory space is available; in future identification marks, the available memory space will rise still further.

In accordance with another feature of the invention, the identification mark used is a passive RF-ID tag that, in a development, can additionally be reusable.

To allocate a greater quantity of information associated with an item of mail to the item of mail in a simple way, the intention being to ensure machine readability, the invention configures an identification mark that can be read without wires or contact, for example a passive RF-ID tag, to store information and/or franking data associated with the item of mail and to be disposed in or on the item of mail.

The identification mark is configured such that any desired information can be stored on it. It is possible for the storage to be performed by the user by a suitable writing device. For example, in particular various franking data such as the franking value, the type of dispatch, the sender, or a corresponding identification of the sender, and the addressee may be contained in encrypted or unencrypted form. The data can be used for the purpose of checking the validity of the franking, but can also be used for sorting and during delivery. The identification mark is additionally configured to be disposed in or on the item of mail. For example, the mark can be configured such that it can be stuck onto the item of mail from the outside or such that it is welded into a film to be enclosed within the item of mail. The storage of the information on the identification mark can be carried out before or after the application in or to the item of mail because storage can be carried out without wires or contact.

With the objects of the invention in view, there is also provided an improvement in a mail processing system processing an item of mail having an identification mark containing information associated with the item of mail. The improvement includes a reading device for reading information associated with the item of mail, the reading device contactlessly and wirelessly reading information stored on the identification mark.

The invention also relates to a mail processing system suitably configured to process an item of mail that has such an identification mark and to read information stored thereon in order to check the franking and, if appropriate, to facilitate delivery. To this end, the mail processing system, such as is provided, for example, in the distribution center or the sorting installation of a postal service, has a corresponding reading device.

In the mail processing system, a writing device is also preferably provided to erase data stored on the identification mark and/or to write new data onto it. For example, cancellation of the franking on the identification mark can also be carried out, after which the identification mark can be reused. It is also possible for further information to be appended that, for example, are important for delivery.

In accordance with a further feature of the invention, the information associated with the item of mail includes franking, and a franking tester tests validity of the franking.

In accordance with an added feature of the invention, the information associated with the item of mail includes delivery data, and there is provided at least one of means for sorting mail and means for following delivery of mail operated based upon the delivery data.

In accordance with an additional feature of the invention, there is provided a writing device at least one of writing and erasing the information associated with the item of mail.

In accordance with yet another feature of the invention, the information associated with the item of mail includes a franking with a franking value, and the writing device cancels the franking by erasing the franking value.

With the objects of the invention in view, there is also provided a writing device for writing information onto an identification mark at an item of mail including a writer contactlessly and wirelessly writing at least one of information and franking data associated with an item of mail at an identification mark of the item of mail.

In accordance with yet a further feature of the invention, the information includes delivery data, and/or the franking data includes a franking value.

In accordance with yet an added feature of the invention, there is provided means for applying the identification mark at the item of mail.

In accordance with yet an additional feature of the invention, there is provided an applicator for applying the identification mark at the item of mail.

In accordance with again another feature of the invention, the information includes delivery data, and there is provided means for inputting the franking data and the delivery data, means for determining the franking data and the delivery data, and means for converting the franking data and the delivery data into the at least one of information and franking data to be written at the identification mark.

With the objects of the invention in view, there is also provided, in a device for processing items of mail, in particular, a franking machine or computer, a writer contactlessly and wirelessly writing at least one of information and franking data associated with an item of mail at an identification mark of the item of mail.

With the objects of the invention in view, there is also provided, in an item of mail, an identifier disposed on the item of mail, the identifier including an identification mark to be contactlessly and wirelessly read, the identification mark storing at least one of information and franking data associated with the item of mail.

The invention further relates to a writing device for writing information onto the identification mark. Such a writing device can be used in a mail processing system described above, but is also important, in particular, for the sender of items of mail for storing franking data and/or other information on the identification mark. Such a writing device can be an appliance that is separate and completely independent of a franking machine, where the franking of the item of mail itself is additionally applied to the item of mail in a conventional way as a postage stamp or as a franking imprint by a conventional franking machine. Otherwise, such additional franking also can be dispensed with if the franking is contained in a complete and recognized form on the identification mark itself, and can be checked by the mail carrier and then also canceled.

However, such a writing device can also be disposed in a device for processing items of mail, in particular, in a franking machine or a computer configured as a franking machine.

Items of mail, in particular, packaging material for items of mail, such as envelopes, package wrappers and package cartons, on or in which such an identification mark is already disposed, is also covered by the invention. According to the invention, such an identification mark can already be integrated into the packaging material for items of mail so that a sender of an item of mail, for example, buys an envelope with an integrated identification mark, and stores the franking and other data only on the identification mark with a suitable storage device. If the entire mail delivery chain, that is to say, from the mail sorting and distribution installation as far as the deliverer of mail, were to be equipped with suitable reading appliances, it would even be possible to dispense completely with the application of the addressee to the item of mail because the information could likewise be stored on the identification mark.

The invention also relates to the use of an identification mark that can be read without wires or contact, and to a method of processing items of mail.

With the objects of the invention in view, there is also provided a method of using of an identification mark including the steps of placing an identification mark at an item of mail, storing at least one of information and franking data associated with an item of mail in the identification mark, and contactlessly and wirelessly reading the identification mark.

In accordance with again a further mode of the invention, the identification mark is a postage stamp.

With the objects of the invention in view, there is also provided a method of processing items of mail including the steps of storing information associated with an item of mail on an identification mark of the item of mail, the information including franking data, and wirelessly reading the information with a reading device and simultaneously checking the validity of the franking data.

In accordance with again an added mode of the invention, delivery data is included in the information, and the item of mail is sorted and/or tracked during transport using the delivery data.

In accordance with again an additional mode of the invention, a franking value is included in the franking data, and the franking value is canceled by storing and erasing the franking value read from the information.

In accordance with still another mode of the invention, the information is encrypted and the encrypted information is interchanged between the reading device and the identification mark.

In accordance with still a further mode of the invention, delivery data is provided for the item of mail exclusively within the information stored, and the item of mail is delivered using the delivery data.

In accordance with a concomitant mode of the invention, storing information is performed by storing information associated with an item of mail on a passive RF-ID tag of the item of mail.

Other features that are considered as characteristic for the invention are set forth in the appended claims.

Although the invention is illustrated and described herein as embodied in an identification mark for storing information, a device for writing information on the mark, and a mark processing system, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a block diagram of a transmitting/receiving appliance and an identification mark according to the invention;

FIG. 2 is a plan view of an envelope configured according to the invention;

FIG. 3 is a block diagram of a franking machine configured according to the invention;

FIG. 4 is a partly broken away perspective view of a PC and components operating as a franking machine configured according to the invention; and

FIG. 5 is a block circuit diagram of a mail processing system according to the invention.

### DESCRIPTION OF THE PREFERRED EMBODIMENTS

In all the figures of the drawing, sub-features and integral parts that correspond to one another bear the same reference symbol in each case.

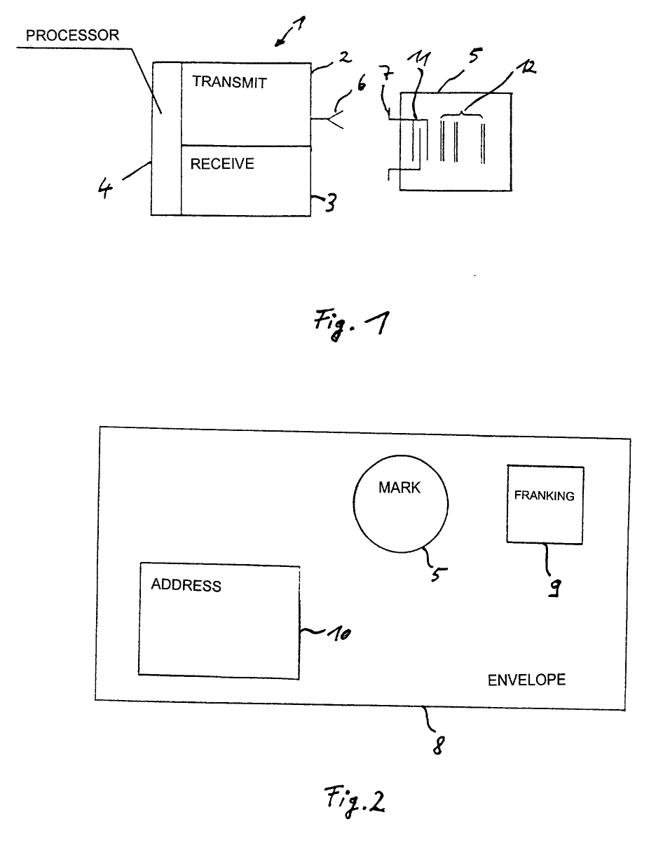

Referring now to the figures of the drawings in detail and first, particularly to FIG. 1 thereof, there is shown a transmitting/receiving appliance 1 having a transmitting part 2, a receiving part 3, evaluation logic 4, and an antenna 6 coupled to the transmitting part 2 to emit an interrogation signal. The identification mark 5 to be interrogated by the transmitting/receiving appliance 1 is configured in FIG. 1 as a passive RF-ID tag. The identification mark 5 has an antenna 7 to receive the interrogation signal, an interdigital converter 11 coupled to the antenna 7 to convert the received interrogation signal into a surface acoustic wave, and a series of reflectors 12 that reflect at least part of the surface acoustic wave back to the interdigital converter 11 and define a code identifying the ID tag 5 in accordance with the reflectors 12.

According to the invention, the identification mark 5 is configured such that a multiplicity of items of information can be stored on it, read, and erased many times without wires or contact. The energy needed for the reading or writing is transmitted on the radio path by the radio connection between the antennas 6, 7. In addition, the identification mark 5 is configured to easily be applied to an item of mail from the outside.

Such an item of mail, specifically an envelope 8, is shown in FIG. 2. As can be seen in FIG. 2, beside the address field 10 and the imprinted franking 9 (or the postage stamp stuck on), there is such an identification mark 5, in which the franking data and, if appropriate, further information, such as the delivery address that is relevant to the letter 8 are stored. The identification mark 5 is stuck on so that it can be detached for reuse.

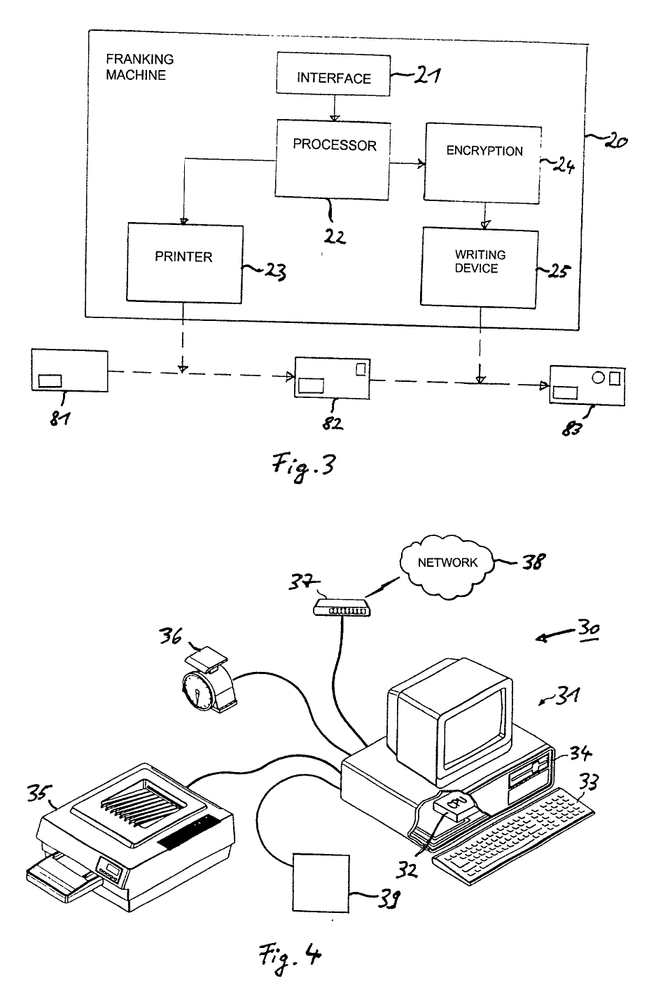

FIG. 3 shows a block diagram of a franking machine 20 according to the invention. The franking machine 20 first has a user interface 21, at which the parameters essential for the franking, such as weight, type of dispatch, country, and so on, can be input. The data is led to a computing unit 22, where the data input is used to determine the franking value, if it was not input directly, and all further data provided for storage on the identification mark. The franking value is then passed onto the printing unit 23, where the franking stamp is printed in the usual way onto an item of mail 81 already provided with an address.

Also provided is an encryption unit 24, in which the data provided for storage on the identification mark are encrypted. The encrypted data are passed onto a writing device 25, from which the encrypted data is then transmitted by radio to the identification mark. The identification mark itself is then applied to the item of mail 82, after which the ready-franked item of mail 83 can pass into the mail chain.

The data is transferred in encrypted form during the writing operation. To ensure such encrypted transfer in the reading operation as well, provision may be made for an encryption unit, for example, an integrated cryptoprocessor, to be provided on the identification mark itself.

Further configurations may be that the identification mark is already a constituent part of the item of mail, that, for example, envelopes with integrated ID tags are marketed, and that when such an envelope is passed by the writing device 25, the information is transferred. It is also conceivable for the identification mark to be welded into a film and enclosed inside the item of mail. In addition, such a film could be printed, for example, with an advertisement or a graphically configured image, to become a collectable object similar to telephone cards. Such identification marks could then be purchased by the user, for example, at the mail carrier, or could be dispatched at no charge by the mail carrier, or given away as an advertisement.

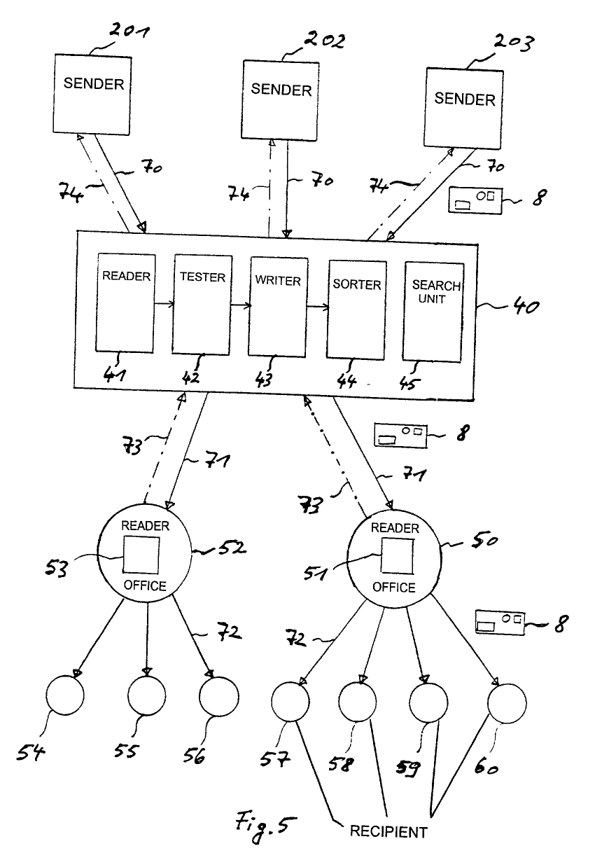

FIG. 4 shows a franking machine 30 that is implemented by a conventional PC 31 which is equipped with suitable hardware and software. The PC 31 itself has a computing unit 32, a keyboard 33, and a disk drive 34 for the input and calculation of data. Connected to the PC 31 are a printing unit 35, a mail-item balance or scale 36, a modem 37 to be connected to a transmission system or network 38, for example, for downloading postal charges from a post office, and a writing device 39 for writing information onto identification marks. Franking can be carried out in the following example. The weight of the item of mail is determined with the balance 34. The PC 31 uses the data and other input data to determine the franking value and the information to be stored. The printer 35 prints the franking stamp, and the writing device 39 writes the information mark. The printer 35 can also be dispensed with completely if the franking can be carried out entirely and exclusively on the identification mark, which then requires an appropriate tester for testing the validity of the franking on the part of the postal authorities or the mail carriers. Such a configuration has the advantage of completely dispensing with the mail-item transport needed to print the item of mail.

Another non-illustrated embodiment configures the writing device as a completely separate (stand-alone) appliance for writing information onto the identification mark. Thus, no further franking and printing of the item of mail is necessary. Then, the appliance could have, as additional appliances, a balance, a modem, and/or a mobile telephone for coupling to the transmission system 38.

A mail processing system according to the invention is shown in FIG. 5. The mail processing system has, centrally, a mail processing unit 40 disposed, for example, in a mail collection and distribution office. As indicated by the arrows 70, the item of mail 8, which has been franked by the sender 201, 202, 203 with franking machines, is delivered to the mail processing unit 40. At the mail processing unit 40, the data contained on the identification mark is read out with a reading device 41, the franking is checked for its validity by a testing device 42 and is checked for an adequate franking value and is then erased by a writing device 43. As a result, the identification mark subsequently arrives at the receiver with an empty charges content and can be reused there. The information contained on the identification mark is also routed to a sorting system 44, which can then sort the item of mail appropriately using the address data contained as information.

Also provided in the mail processing unit 40 is a mail search unit 45, in which at least part of the data contained on the identification mark is stored for a certain time. As a result, information as to whether and when an item of mail passed through the mail processing unit 40 is made available. The information can be used advantageously for the purpose of following the transport of the item of mail, if appropriate, to give feedback to the user about the mail and to facilitate finding it in the even of loss.

The item of mail 8 is then passed on further, as shown by arrow 71, to the mail delivery offices 50, 52. The item of mail, as indicated by arrows 72, is delivered from the mail delivery offices 50, 52 to the receivers 54 to 60. The mail delivery offices 50, 52 each has a reading unit 51, 53 for reading the information contained on the identification mark, in particular, the address data, for facilitating delivery. In addition, it is then possible, as indicated by arrows 73, to give feedback to the mail processing unit 40, in particular, to the mail search unit 45, in order to document the mail chain. From there, feedback relating to the delivery and the mail chain can also be given to the senders 201 to 203, as indicated by arrows 74. If the mail delivery offices 50, 52, for example, all mail carriers, have such reading devices 51, 53, writing on the item of mail can also be dispensed with completely if the address data of the receiver is contained in the identification marks. As such, unauthorized use of an identification mark loaded with money, or its theft, is not practical because an item of mail to which the identification mark is applied will also reach only a specific receiver and cannot be used for other dispatches of items of mail having a different receiver.

All the problems arising in connection with the printing quality, the paper, and the machine readability in conventional franking machines no longer occur in the solution according to the invention. Transmitting data to the reading device is reliably possible even over a relatively large distance and with an undefined orientation of the item of mail. The invention additionally reduces the outlay for guiding the item of mail in the area of the reading device. The identification marks used can also be produced cheaply and simply and can be read and written in a simple way with a simple device. Even the application of the identification marks in or on the item of mail does not require any great effort.

The invention is not restricted to the embodiments shown. Instead, with regard to the actual configuration, many variations and possible extensions are conceivable. For example, the invention is not restricted to a specific identification mark that can be read without wires or contact, of which there is a series of solutions operating on different principles. In addition to the ID tags described at the beginning and operating with surface acoustic waves, there are, for example, also identification marks in which a coil is integrated for the wireless transmission of energy, and a storage element for storing a series of values.

It is also conceivable, at the time of writing an identification mark, to store the time (date and time of day) of the writing operation and/or an expiry date with a stored franking. For example, provision can be made for the values stored on the identification mark not to be capable of being changed or erased for a specific time period, for example, two to three days, to ensure security against counterfeiting. In addition, a stored expiry date or an expiry date calculated when reading the stored values from the likewise stored time of the writing operation could be used when checking the validity of a franking for preventing counterfeiting and misuse.

As indicated in FIG. 5, the invention can also advantageously be used for tracking and tracing, that is to say, following the item of mail during delivery or in the event of losses. To accomplish tracking/tracing, for example, provision may be made for memory space to be reserved on the identification mark such that, at each station in the transport of the item of mail, that is to say, at the mail collection office, at the sorting office, and the distribution stations, a respective corresponding passage code is stored on the identification mark. Additionally or alternatively, a code stored on the identification mark can also be stored at the corresponding passage stations. The code information can be used for informing the customer about the current location during the delivery of the item of mail and, if appropriate, to facilitate finding it again in the event of loss.

We claim:

1. A mail identifier for storing information at an item of mail, comprising:
an identification mark disposed at an item of mail, said identification mark having a storage device for storing at least one of information and franking data associated with the mail item, said storage device to be contactlessly and wirelessly read.

2. The identification mark according to claim 1, wherein said identification mark is disposed on the item of mail

3. The identification mark according to claim 1, wherein said identification mark is disposed in the item of mail

4. The identification mark according to claim 1, wherein said identification mark is an RF-ID tag.

5. The identification mark according to claim 1, wherein said identification mark is reusable.

6. In a mail processing system processing an item of mail having an identification mark containing information associated with the item of mail, the improvement comprising:
a reading device for reading information associated with the item of mail, said reading device contactlessly and wirelessly reading information stored on the identification mark.

7. The mail processing system according to claim 6, wherein the information associated with the item of mail includes franking, and a franking tester tests validity of the franking.

8. The mail processing system according to claim 6, wherein the information associated with the item of mail includes delivery data, and at least one of means for sorting mail and means for following delivery of mail operated based upon the delivery data.

9. The mail processing system according to claim 6, wherein the information associated with the item of mail includes delivery data, and at least one of a sorter sorting mail and a tracker tracking mail operate based upon the delivery data.

10. The mail processing system according to claim 6, including a writing device at least one of writing and erasing the information associated with the item of mail.

11. The mail processing system according to claim 10, wherein:
the information associated with the item of mail includes a franking with a franking value; and
said writing device cancels the franking by erasing the franking value.

12. A writing device for writing information onto an identification mark at an item of mail, comprising:
a writer contactlessly and wirelessly writing at least one of information and franking data associated with an item of mail at an identification mark of the item of mail.

13. The writing device according to claim 12, wherein the information includes delivery data.

14. The writing device according to claim 12, wherein the franking data includes a franking value.

15. In a device for processing items of mail, a writing device comprising:
a writer contactlessly and wirelessly writing at least one of information and franking data associated with an item of mail at an identification mark of the item of mail.

16. The device according to claim 15, including means for applying the identification mark at the item of mail.

17. The device according to claim 15, including an applicator for applying the identification mark at the item of mail.

18. The device according to claim 15, wherein the information includes delivery data, and including means for inputting the franking data and the delivery data, means for determining the franking data and the delivery data, and means for converting the franking data and the delivery data into the at least one of information and franking data to be written at the identification mark.

19. In a device for processing items of mail, a franking machine comprising:
a writer contactlessly and wirelessly writing at least one of information and franking data associated with an item of mail at an identification mark of the item of mail.

20. In a device for processing items of mail, a computer comprising:
a writer contactlessly and wirelessly writing at least one of information and franking data associated with an item of mail at an identification mark of the item of mail.

21. In an item of mail, an identifier disposed on the item of mail, the identifier comprising:
an identification mark to be contactlessly and wirelessly read, said identification mark storing at least one of information and franking data associated with the item of mail.

22. The identifier according to claim 21, wherein the item of mail is one of the group consisting of a mail packaging material, an envelope, a package wrapper, and a package carton.

23. A method of using of an identification mark, which comprises:
placing an identification mark at an item of mail;
storing at least one of information and franking data associated with an item of mail in the identification mark; and
contactlessly and wirelessly reading the identification mark.

24. The method according to claim 23, wherein the placing step is performed by placing a postage stamp at an item of mail.

25. A method of processing items of mail, which comprises:
storing information associated with an item of mail on an identification mark of the item of mail, the information including franking data; and
wirelessly reading the information with a reading device and simultaneously checking the validity of the franking data.

26. The method according to claim 25, which further comprises including delivery data in the information, and at least one of sorting and tracking the item of mail during transport using the delivery data.

27. The method according to claim 25, which further comprises including a franking value in the franking data, and canceling the franking value by storing and erasing the franking value read from the information.

28. The method according to claim 25, which further comprises encrypting the information and interchanging the encrypted information between the reading device and the identification mark.

29. The method according to claim 25, which further comprises:
providing delivery data for the item of mail exclusively within the information stored; and
delivering the item of mail using the delivery data.

30. The method according to claim 25, which further comprises carrying out the storing step is performed by storing information associated with an item of mail on a passive RF-ID tag of the item of mail.
